(19) United States
(12) Patent Application Publication
(10) Pub. No.: US 2013/0022339 A1
(43) Pub. Date: Jan. 24, 2013

(54) LOCAL HEAT TREATMENT OF IBR BLADE USING INFRARED HEATING

(71) Applicants: Thomas DeMichael, Stafford Springs, CT (US); James J. Moor, New Hartford, CT (US); Herbert A. Chin, Portland, CT (US); Wangen Lin, South Glastonbury, CT (US)

(72) Inventors: Thomas DeMichael, Stafford Springs, CT (US); James J. Moor, New Hartford, CT (US); Herbert A. Chin, Portland, CT (US); Wangen Lin, South Glastonbury, CT (US)

(73) Assignee: UNITED TECHNOLOGIES CORPORATION, Hartford, CT (US)

(21) Appl. No.: 13/184,733

(22) Filed: Jul. 18, 2011

(51) Int. Cl. H05B 1/00

(52) U.S. Cl. 392/422

(57) ABSTRACT

A device and method for locally heat treating at least one airfoil in an integrally bladed rotor device. A pair of IR heat sources are positioned to direct IR heat rays in the direction where local heat treatment is required. A pair of parabolic mirrors are positioned to direct the IR heat rays on to the metal component. The heat treating is useful after welding the airfoil on to the rotor device.

### BACKGROUND

The manufacture, service and/or repair of metal components, such as gas turbine engines, often times require localized heating of specific areas of the components. This is done, for example, to allow for stress relief, metal forming and/or brazing applications. Localized heating is preferred when processing the entire component could adversely affect the metallurgical properties of the component. Warping and other forms of deformation are also to be avoided.

Integrally bladed rotors are used in some gas turbine engines and are expected to be used even more as engine designs continue to evolve. Upon original manufacture, all integrally bladed rotor material is heat treated to obtain the desired mechanical properties prior to finish dimension machining.

During blade repair operations, it may be necessary to locally heat treat the repaired areas of the integrally bladed rotors that have been exposed to elevated temperatures. In the finished machine condition, conventional heat treatment is not always possible due to concerns with distortion. Additionally, conventional heat treatment of a finished machined integrally bladed rotor may create unnecessary risk due to the potential for surface contamination throughout the entire part. Because of these concerns, local heat treatment has been considered to be a desirable option.

### SUMMARY

The present invention comprises the use of focused infrared heat lamps to locally heat treat and/or stress relieve portions of integrally bladed rotors without adversely impacting other critical areas of the integrally bladed rotors. This is done by the use of infrared heat sources on the individual integral blades in an inert environment which in one form uses parabolic minors to focus heat only onto the desired area. A fixture is provided that locates the device at the precise location where heat is to be applied to a localized area, such as after a replacement blade has been attached by welding to a rotor. The present invention may also be used in the initial manufacture of integrally bladed rotors to locally heat treat areas after details have been attached to the rotor, such as by welding or to locally create alternate material properties.

### BRIEF DESCRIPTION OF THE DRAWINGS

FIG. 1 is a perspective view showing the device of this invention.

FIG. 2 is a plan view showing the device of this invention focused on a single integrally bladed rotor.

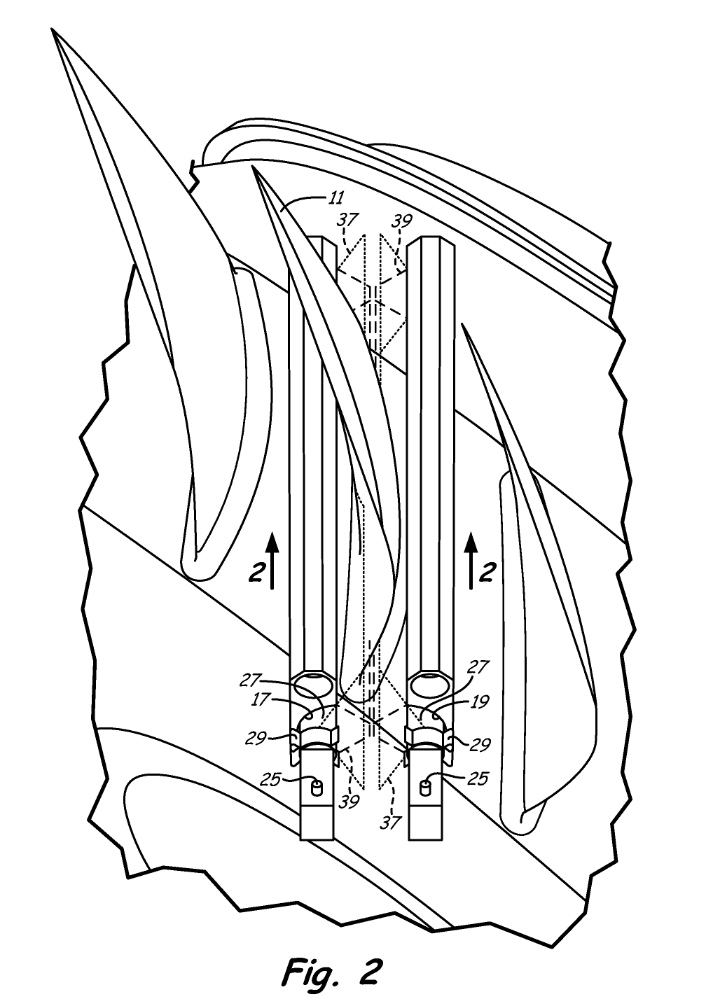

FIG. 3 is a section view taken along line 2-2 of FIG: 2.

### DETAILED DESCRIPTION

Device 10 is positioned proximate an integrally bladed rotor (IBR) airfoil 11 for heating a portion of the IBR airfoil 11 and thereby eliminate overall part exposure to heat. Device 10 includes a pair of infrared (IR) lamp housings 13 and 15, each with an IR lamp generating IR rays that are reflected off parabolic minors 17 and 19, respectively, to contact IBR 11 and heat treat that blade without exposing any other part of IBR airfoil 11 to unwanted heat.

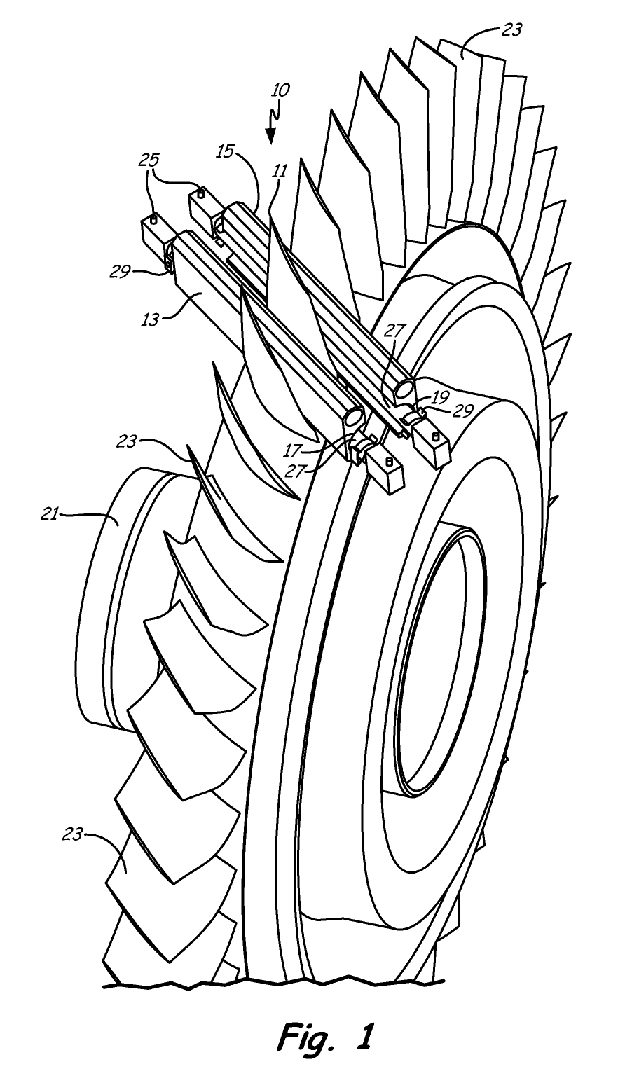

FIG. 1 illustrates a complete integrally bladed rotor with rotor hub 21 supporting a plurality of other airfoils 23. Device 10 is positioned on airfoil 11 and includes electrical contacts 25 connected to a power source, not shown, for actuation of IR lamps 27 that are held in place by clips 29. Rays from IR lamps 27 are focused by minors 17 and 19 as an elongated band of IR radiation on a specific portion of airfoil 11, in this instance the portion of airfoil 11 attached to rotor hub 21. The width of the band of focused IR radiation may be any width that permits complete heat treatment of the desired portions of the component. Band widths may range from about 6 mm to about 18 mm, and may be about a 12 mm band width. Other widths may also be accommodated depending on, for example, the size of the parts, the material being heat treated

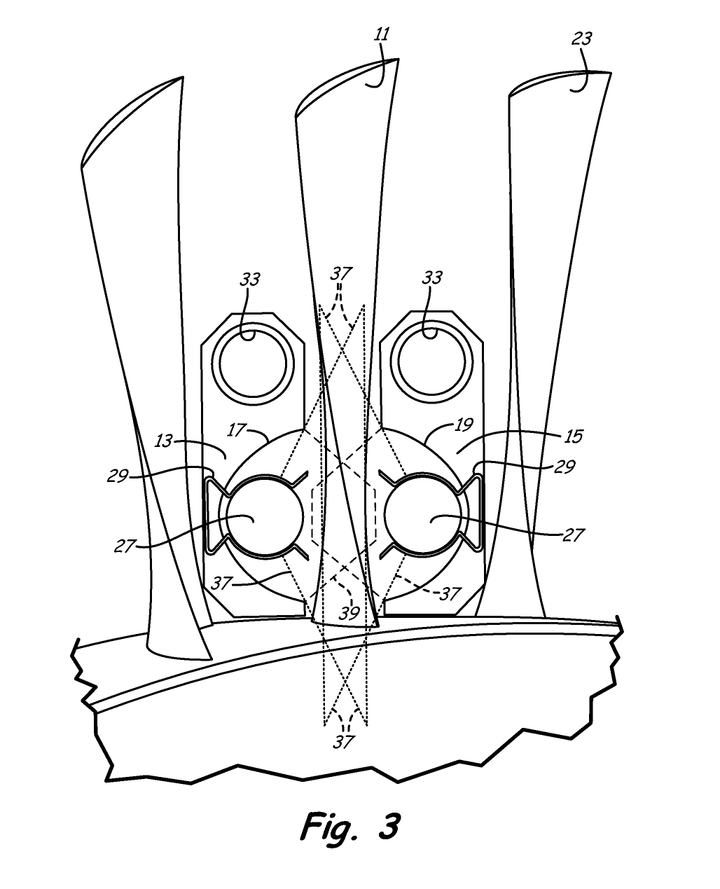

Device 10 also includes tubes or passages 33, shown more clearly in FIG. 3, that are connected to a source of water or other cooling medium, not shown, to cool portions of device 10 to prevent distortion and a resulting uneven heating. Other cooling devices such as fans and refrigerants may also be used.

Also shown in FIG. 3 are dotted lines 37 that represent the extent of unfocused IR rays from lamps 27, and dashed lines 39 represent the extent of IR rays focused by minors 17 and 19 onto the portion of airfoil 11 that is to be heat treated, such as to relieve stress in the metal after welding airfoil 11 to rotor hub 21.

It is known that heat treatment in the presence of oxygen can cause titanium alloys to become embrittled if the temperature exceeds 1,000° F. (538° C.). In addition to embrittlement, the material properties of titanium alloys changes if it is exposed to a temperature exceeding 800° F. (427° C.), but as will be understood the actual temperature depends on the specific alloy. Oxygen contamination at referenced temperatures can be avoided by proper protection such as the use of inert shielding gas. The present invention ensures that the portion(s) of the product being treated will receive desired thermal treatment but generally remain below 1,000° F. (538° C.) and even below 800° F. (427° C.).

The present invention was used to heat treat and stress relieve a plurality of IBR blades without adversely heating other critical areas of the IBR. In addition, replacement blades have been attached to an IBR by focusing the heat only at the desired location, e.g., where the replacement blade is attached to the IBR. A complete blade replacement for an IBR using the present invention produced no stress or distortion on the rest of the assembly. The device of this invention is suitable for OEM manufacture and for repair of existing IBR systems.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A device for heat treating a metal component, comprising:
at least one parabolic mirror formed in the axially extending cavity; and
at least one IR heat source for providing IR heat rays in a direction toward the at least one parabolic mirror;
such that the at least one parabolic mirror is positioned to focus a band of the IR heat rays onto the metal component.

2. The device of claim 1, wherein the metal part is at least one airfoil in an integrally bladed rotor.

3. The device of claim 2, wherein the IR heat source and parabolic mirror are sized to direct the IR heat rays along the junction between the airfoil and the integrally bladed rotor device.

4. The device of claim 3, which includes a pair of housings on opposite sides of the entire area of contact between the airfoil and the integrally bladed rotor device, with each housing having an IR heat source and a parabolic mirror formed in the housing for each IR heat source.

5. The device of claim 4, wherein each of the pair of IR heat sources are mounted to its respective housing with a clip.

6. The device of claim 5, wherein the parabolic minor directs the IR heat rays to a region of the airfoil where it is joined to the integrally bladed rotor device.

7. The device of claim 1, wherein the IR heat rays are focused into an elongated band having a band width of from about 6 mm to about 18 mm.

8. The device of claim 2, which further includes a cooling element for each IR heat source for maintaining a desired temperature for the IR heat source.

9. The device of claim 8, wherein the cooling element is part of the housing having an axial passage adapted to transfer cooling liquid through the passage, and the housing extends along the airfoil.

10. The device of claim 9, wherein the housing includes a cavity forming a parabolic minor and the IR heat source is mounted in the cavity to focus the IR heat rays on the junction of the airfoil where it is joined to the integrally bladed rotor device.

11. A system for heat treating at least one airfoil in an integrally bladed rotor device, the system comprising:
at least one IR heat source means mounted in a position for directing IR heat rays in a direction; and
at least one parabolic mirror means for reflecting the IR rays on to the at least one portion of an airfoil.

12. The system of claim 11, which includes a pair of housings each having an axially extending cavity, the cavity forming the parabolic minor, the housings further each positioning an IR heat source, wherein the pair of IR heat sources are facing in opposite directions and each IR heat source is aligned with the parabolic minor.

13. The system of claim 12, wherein the parabolic minor directs the IR heat rays radially inward to the airfoil where it is joined to the integrally bladed rotor device.

14. The system of claim 13, which further includes a cooling element for each IR heat source for maintaining a desired temperature for the IR heat source.

15. The system of claim 14, wherein the cooling element is part of a housing having an axial passage adapted to transfer cooling liquid through the passage, and the housing extends along the width of the airfoil.

16. A method for heat treating at least one airfoil in an integrally bladed rotor device having a rotor and a plurality of blades, comprising:
providing a pair of housings each having an axially extending cavity, the cavity including a surface forming a parabolic mirror;
positioning an IR heat sources proximate each parabolic mirror, wherein the IR heat sources are facing in opposite directions and each IR heat source is aligned with its parabolic mirror to direct IR heat rays in a direction radially inward to the airfoil where it is joined to the integrally bladed rotor device; and
cooling each IR heat source to maintain a desired temperature for the IR heat source, the cooling element being part of the housing and having an axial passage adapted to transfer cooling liquid through the passage.

17. The method of claim 16, wherein the IR heat rays are focused into an elongated band having a band width of from about 6 mm to about 18 mm.

18. The method of claim 16, wherein the heat rays heat the metal component to a temperature of at least 1,300° F. (704° C.) and the cooling element maintains the adjacent areas adjacent areas of the metal component below 1,000° F. (538° C.).
